(19) United States
(12) Patent Application Publication
(10) Pub. No.: US 2005/0254430 A1
(43) Pub. Date: Nov. 17, 2005

(54) Method and apparatus for optimized routing in networks that include free space directional links

(76) Inventors: Pamela H. Clark, Herndon, VA (US); Ralph Maxwell Williams, Leesburg, VA (US); Jaenho A. Oh, Fairfax, VA (US)

Correspondence Address: EDELL, SHAPIRO & FINNAN, LLC, 1901 RESEARCH BOULEVARD, SUITE 400, ROCKVILLE, MD, 20850, US

(21) Appl. No.: 10/844,374

(22) Filed: May 13, 2004

(51) Int. Cl. H04L 1/00

(52) U.S. Cl. 370/241

(57) ABSTRACT

A method and apparatus is described for optimized routing in networks that include a free space directional link. A free space directional link within a network is monitored at the physical and/or data link layer and a router/routing layer protocol is notified regarding the status of the monitored free space directional link. By monitoring the transmitted signal at the physical and/or data link layer, the present invention avoids reliance upon less frequent control messages to determine free space directional link status, thereby allowing the router/routing layer to be notified more quickly of, and respond more quickly to, changes in free space directional link status.

### BACKGROUND OF THE INVENTION

1. Field of the Invention

The present invention pertains to free space directional communication. In particular, the present invention pertains to improvements in responsiveness of the routing protocol within in a network that includes at least one free space directional link.

2. Description of the Related Art

Conventional routing protocols, such as Routing Information Protocol (RIP), Cisco's EIGRP (Enhanced Interior Gateway Routing Protocol), and OSPF (Open Shortest Path First) were designed for routing information within networks with relatively stable physical network topologies. In such networks, network nodes are typically interconnected using fixed physical media communication lines, such as metal wire conductors and/or optical fibers, that are relatively stable and typically not subject to random and/or continuous configuration changes.

Such routing protocols generally route messages within a network based upon dynamic routing tables maintained by each node within the network. Routing tables are typically built by a network node based upon information received from neighboring nodes in response to “Hello” signals broadcast by the node to its neighboring nodes. For example, in response to broadcasting a Hello message, a broadcasting node may receive multiple Hello acknowledgements, each identifying the node (i.e., neighbor) that received the original broadcast message. Further, the Hello acknowledgement may contain information related to the neighbor node's neighbors and/or a current copy of the neighbor node's routing table.

By periodically broadcasting Hello messages a node is able to build and dynamically maintain a routing table based upon the information received in Hello acknowledgment messages received from the broadcasting node's neighbors. In addition, some protocols may be configured for a node to generate Hello messages containing updated neighbor and routing table information in response to detecting a change, either in the status of links to its own neighbors and/or changes in routing table information received from its neighbors. Therefore, depending upon the number of nodes in the network, control message overhead related to periodic broadcasts of Hello messages, responses (e.g., acknowledgements) to periodic Hello messages, as well as the spontaneous propagation of link-failure and link-restored messages can result in significant control overhead.

In ad-hoc mobile radio based networks, neighbors of an individual radio node are those radio nodes within broadcast range of the node. The physical topology of such ad-hoc radio networks may change rapidly as individual radios move out of broadcast range of one set of radio nodes and into the broadcast range of another set of radio nodes. Further instability is introduced in the physical network topology of such radio ad hoc networks by natural and man-made objects that may serve as sources of interference to communication between one or more nodes within the network. Even if such sources of interference are stationary, the effects of such sources of interference may introduce dynamic changes to the topology of the network due to the movement of the respective ad hoc nodes relative to the source of interference.

When protocols such as RIP, EIGRP, and OSPF are applied to networks with dynamically changing topologies, such as ad-hoc mobile radio networks, significant inefficiencies are introduced due to the control messages that must be relayed between network nodes in order to dynamically update the routing information that is distributed throughout the network on the individual nodes. For example, even a protocol such as RIP, in which each node stores only a single preferred route, requires significant time for the respective network nodes to reach convergence (i.e., consistency/agreement across all nodes in the network) with respect to the new physical network topology. Further, a protocol such as OSPF, in which each node stores topology information for the entire network, re-broadcasting complete topology information between nodes results in a significant increase in network control message overhead.

The effect of introducing free space directional communication links into an otherwise conventional, static network topology that uses a conventional routing protocol introduces to the network many of the same network topology/network routing issues experienced by ad-hoc mobile radio networks that attempt to use conventional routing protocols, as described above. Free space directional communication links may include a link that spans a free space using any of a wide range of transmission technologies including, but not limited to, narrow directional radio wave communication and/or optical transmissions based upon coherent and/or incoherent, narrow and/or broad spectrum optical light transmissions. A free space directional link provides a one-way or two-way communication link between two communicating nodes. Information between nodes using a free space directional link is passed on a one-to-one basis rather than on a one-to-many basis, as is typically used in mobile radio based networks that use free space non-directional radio broadcasts.

Given that free space directional links communicate across free space (i.e., through the atmosphere, the upper atmosphere and/or outer space), sources of interference may include: terrestrial objects, that may include but are not limited to buildings, trees, mountains, etc.; atmospheric sources of interference, that may include but are not limited to temperature differentials, humidity, clouds, smog, rain, snow, hail, etc.; terrestrial and airborne man-made sources of electromagnetic radiation, such as radio towers, other aircraft, satellites, etc.; extraterrestrial bodies, that may include but are not limited to planets, moons, etc.; and/or extraterrestrial sources of electromagnetic radiation, that may include but are not limited to radiation from solar flares and/or other extraterrestrial sources of electromagnetic radiation.

Sources of interference to free space directional links may periodically and/or sporadically affect the quality of the communication signal between two nodes communicating via a free space directional link. Both optics based and directional radio links, due to their narrow directional nature, are highly affected by any object that may block, reflect, distort, bend, re-radiate, and/or otherwise affect the characteristics of a free space directional transmission. Further, narrow beam free space communication links are often selected for use in networks that support communication between combat operational units, such as a combination of mobile infantry units, tanks, ships and/or aircraft and/or satellites, any of which may be subject to loss during combat or other high risk operational activities.

Use of conventional routing protocols in a network that includes one or more free space directional links, particularly in a network in which distortion and/or failure of the free space directional link can be frequent and unpredictable (e.g., mobile networks), results in severe degradation in network performance, due to the method used by these conventional routing protocols to detect free space link failures. Conventional protocols, such as RIP, EIGRP, and OSPF typically use the transmission and acknowledgement, or in the case of a failure, the lack of acknowledgement, of periodic Hello messages, described above, to determine the connectivity of the network, and by extension, the available routing paths within the network. Typically, these conventional protocols wait for a predetermined number of Hello periods (e.g., three), before the node declares the link interface down and begins re-routing procedures. Three Hello periods range from between 15 seconds and 90 seconds, depending on the protocol (15 seconds for EIGRP, 40 seconds for OSPF). Thus, a link failure can result in a significant service outage, despite the availability of an alternate route, even before a router discovers that re-routing is necessary. At the high data rates typically associated with free space optical links, the impact on performance may be severe.

Although the Hello interval in these conventional protocols may be a configurable parameter, and may be set to a very low value to catch link outages more quickly, the resulting increase in routing overhead prohibits setting the interval low enough to effectively avoid link failure-induced service outages. To address this problem, dynamic routing protocols are being developed for mobile ad hoc networks (MANET). Each MANET protocol has mechanisms for discovering link failures; however, the MANET protocols under development are designed for a broadcast medium (such as networks based upon free space omni-directional transmitters/receivers) and, therefore, are not suited for efficiently detecting the failure and re-computing a route between two communicating nodes.

Hence, a need remains for an apparatus and method capable of reducing and/or eliminating service outages in networks that employ free space directional communication links. Preferably, such an approach would quickly detect free space directional link failures and allow a node to re-route node-to-node communication with sufficient speed so that service outages are avoided. Further, such an approach would preferably detect the restoration of a directional communication link and allow routing tables to be rapidly restored to reflect the current status of the newly available communication link. Still further, such an approach would preferably be capable of distinguishing between a failed link and a link that is only temporarily impaired so as to avoid unnecessary network routing changes. By mitigating the effects of free space directional communication link failures upon overall network routing performance, such an approach would preferably result in a free space directional link network with a decreased number of network delays, and increased availability, thereby reducing the amount of retransmitted data and contributing to improved network performance and reliability.

### OBJECTS AND SUMMARY OF THE INVENTION

Therefore, in light of the above, and for other reasons that may become apparent when the invention is fully described, an object of the present invention is to reduce transmission delays due to the failure of free space directional links within a network.

Another object of the present invention is to increase the availability, reliability, and throughput of networks that include free space directional links.

Yet another object of the present invention is to increase the speed with which the network routing layer of a network responds to a failed free space directional link within a network.

Still another object of the present invention is to avoid unnecessary re-routing due to limited and/or temporary free space directional link degradation.

A further object of the present invention is to reduce the control message overhead associated with redirecting messages in response to a failed free space directional link.

The aforesaid objects are achieved individually and in combination, and it is not intended that the present invention be construed as requiring two or more of the objects to be combined unless expressly required by the claims attached hereto.

A method and apparatus is described for optimized routing in networks that include free space directional links. A free space directional link within a network is monitored at the physical and/or data link layer and a new/optimized router/routing layer protocol is notified regarding the status and/or changes in the status of the monitored free space directional link. A free space directional link signal is received/monitored and the quality of the free space directional link signal is assessed to determine whether the signal quality complies with a set of stored signal characteristic information/requirements. If the received signal does not comply with stored signal characteristic information/requirements, and the free space link has been up, the link monitor notifies the router/routing layer of a link failure. If the received signal complies with stored signal characteristic information/requirements, and the free space has been down, the router/routing layer is notified of the restored directional link.

By monitoring signal strength and/or data traffic, the present invention may avoid reliance upon significantly less frequent control traffic to determine whether a free space directional link has been lost or has been restored. The signal power of any received signal (e.g., an optical or electromagnetic signal) may be used because the highly directional nature of a free space directional link assures that any received signal corresponds to the link in question.

Assessment of signal quality may include considerations for the possible causes of link failure and characteristics associated with the respective possible causes of link failure. For example, to avoid unnecessary re-routing of network traffic, an optical link monitor is configured with threshold parameters to avoid declaring a link failure for extremely short-term scintillation-induced fades. Upon receipt of a link status update indicating failure of a free space directional link, a router/routing layer determines whether an alternate route is available. If an alternate route is available, the network traffic may be routed over the alternate network link. Upon receipt of a link status update indicating that a free space directional link has been restored, the router/routing layer may re-route traffic across the newly restored free space directional link.

Significant improvement in performance may be achieved by maximizing the link redundancy at each node to ensure that a node's routing information table includes multiple alternate routes. Such a precaution increases the probability that a re-routing decision may be made locally (e.g., a node may route traffic upon an alternate link supported by the same node as the failed link) and reduces the need for a node's router/routing protocol to search for and discover new routes (e.g., by sending route discovery messages), which may result in significant data traffic transmission delays. By monitoring a free space directional link to detect link failures and link recoveries based upon a set of predetermined link failure and link recovery thresholds, the time required for the router/routing layer to re-route network traffic in response to a failure or a recovery of a free space directional link is greatly reduced.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1A is a block diagram of a free space directional link monitor and a router/routing layer protocol that is configured to receive free space directional link status updates from the free space directional link monitor and adjust network traffic routing in response to the received directional link status updates.

FIG. 1B is a block diagram of an apparatus capable of routing/re-routing traffic in response to receipt of a free space directional link status update.

FIG. 2 is a process flow diagram for monitoring a free space directional link and notifying an optimized routing device/routing layer protocol of the status of the free space directional link in accordance with an exemplary embodiment of the present invention.

FIG. 3 is a process flow diagram for routing/re-routing messages in a network that includes a free space directional link in response to free space directional link status notifications received from a free space directional link monitor in accordance with an exemplary embodiment of the present invention.

FIG. 4A is a data chart presenting a loss of service (availability) in response to a failed free space directional communication link in a network using a conventional routing protocol.

FIG. 4B is a data chart presenting service continuity despite a failed free space directional communication link in a network due to the use of a free space directional link monitor and a routing protocol optimized in accordance with the present invention.

FIG. 5A is a data chart presenting the probability and duration of a transmission delay in response to a failed free space directional communication link in a network using a conventional routing protocol.

FIG. 5B is a data chart presenting the probability and duration of a transmission delay in response to a failed free space directional communication link in a network that uses a link monitor and router/routing protocol optimized in accordance with the present invention.

### DETAILED DESCRIPTION OF THE PREFERRED EMBODIMENTS

A free space directional communication link, as described below, may include any optical or radio frequency signal link that spans a free space using any of a wide range of transmission technologies including, but not limited to, narrow directional radio wave communication and/or optical transmissions based upon coherent and/or incoherent, narrow and/or broad spectrum optical light transmissions. A free space directional link provides a one-way or two-way communication link between communicating nodes located at two distinct locations. Information between nodes using a free space directional link is passed on a one-to-one basis rather than on a one-to-many basis, as is typically used in mobile radio based networks that use free space non-directional radio broadcasts.

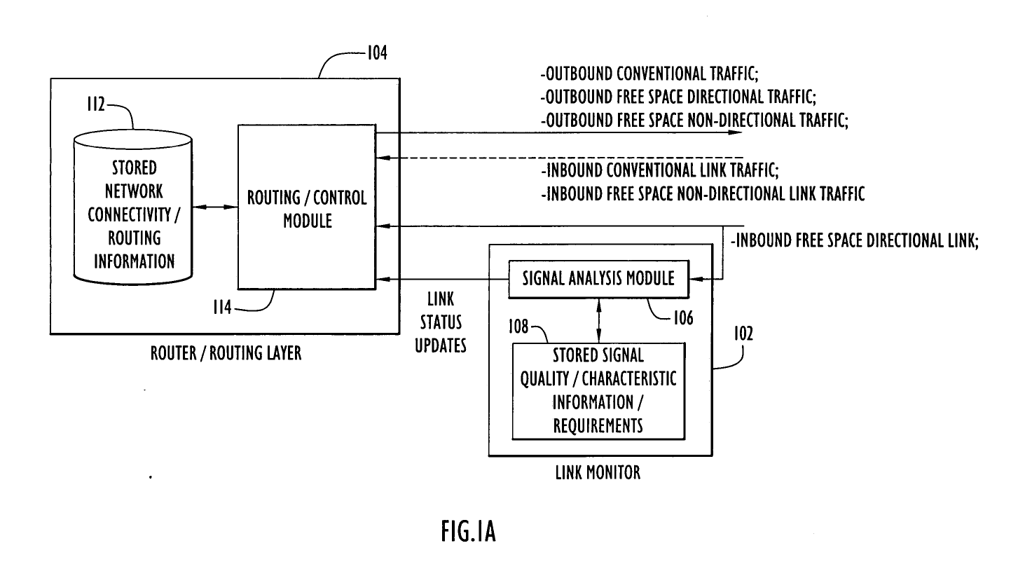

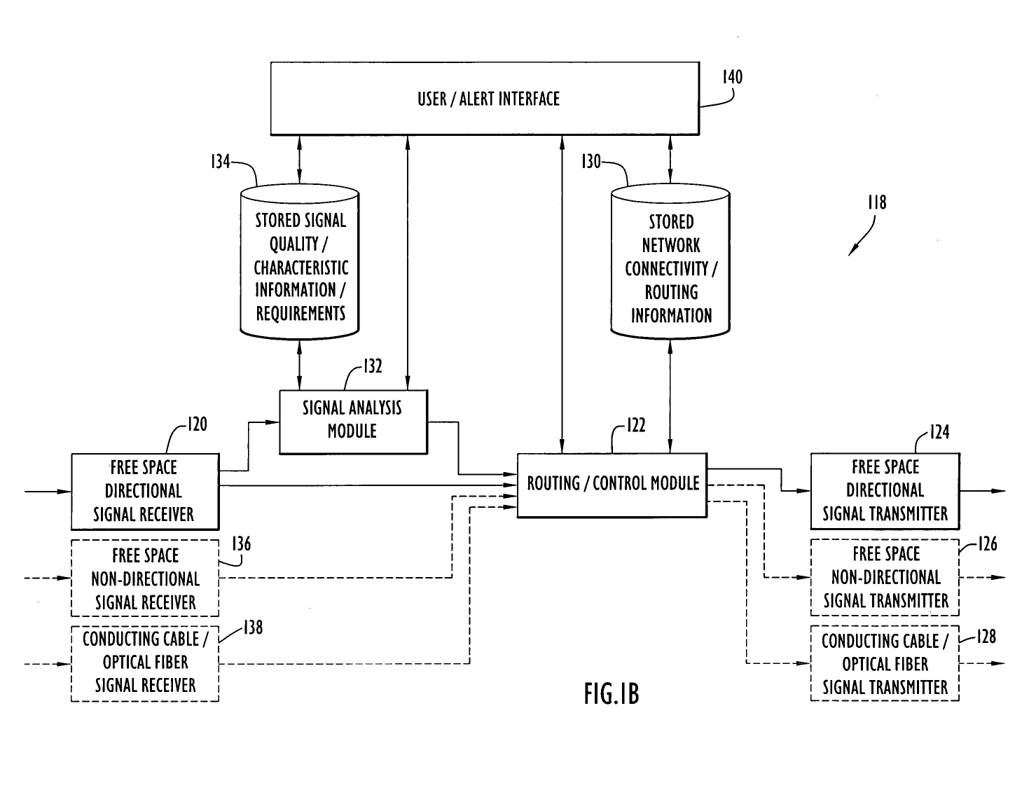

FIG. 1A is a block diagram of a free space directional link monitor 102 and a router/routing layer protocol 104 that is configured to receive free space directional link status updates from free space directional link monitor 102 and to adjust the routing of network traffic in response to the received directional link status updates, as necessary. Free space directional link monitor 102 may include signal analysis module 106 in communication with stored signal characteristic information/requirements 108. Router/routing layer protocol 104 may include routing/control module 114 in communication with stored network connectivity/routing information 112.

As shown in FIG. 1A, signal analysis module 106 may receive an inbound free space directional link signal and assess the quality of the signal based upon criteria retrieved from stored signal characteristic information/requirements 108. Upon analyzing an inbound free space signal, signal analysis module 106 may send a link status update to router/routing layer protocol 104 indicating the status of the inbound free space directional link signal. For example, in one representative embodiment the inbound free space directional link signal notifies router/routing layer protocol 104 whether a free space directional link is up or down. In another representative embodiment, the inbound free space directional link monitor notifies router/routing layer protocol 104 whether the incoming signal complies with or fails to comply with stored signal characteristic information/requirements 108, thereby allowing router/routing layer protocol 104 to determine the status of the link based upon information stored within network connectivity/routing information 112.

As further shown in FIG. 1A, router/routing layer protocol 104 may receive inbound free space directional link traffic upon a free space directional link via routing/control module 114 and may route the incoming traffic as outbound traffic upon one or more outbound links in accordance with internally stored routing tables/information retrieved by routing/control module 114 from stored network connectivity/routing information 112. Further, router/routing layer protocol 104 may receive link status updates from free space directional link monitor 102 via routing/control module 114. Routing/control module 114 may update stored network connectivity/routing information 112 in response to receipt of a link status update. Further, routing module 114 may proceed to re-route traffic based upon the impact of the newly received link status update upon current network traffic routing activities.

In operation, receipt by router/routing layer protocol 104 of free space directional link updates from free space directional link monitor 102 greatly increases the efficiency with which router/routing layer protocol 104 may proceed to re-direct traffic via an alternate or a more optimal route in response to receipt of a link status update indicating that a previously up link has gone down, or a previously down link has been restored, respectively, as described in greater detail below.

FIG. 1B is a block diagram of network router, or node, capable of rapidly routing/re-routing network traffic via at least one of an alternate and an optimal route in response to a change in a status of a free space directional link. As shown in FIG. 1B, network node 118 may include a user interface 140 in communication with stored signal characteristic information/requirements 134, signal analysis module 132, routing/control module 122 and stored network connectivity/routing information 130. As further shown in FIG. 1B, such a network router, or node, may include any number of signal receivers and signal transmitters for use in receiving and transmitting network traffic across a wide assortment of network links. For example in FIG. 1B, routing/control module 122 may receive incoming network traffic via one of free space directional signal receiver 120, free space non-directional signal receiver 136 and conducting cable/optical fiber signal receiver 138 and may transmit outgoing network traffic via one of free space directional signal transmitter 124, free space non-directional signal transmitter 126 and conducting cable/optical fiber signal transmitter 128. In FIG. 1B, dashed lines are used to indicate optional components. For example, in a network node 118 that receives and transmits only free space directional signals over free space directional links, free space non-directional signal receiver 136, conducting cable/optical fiber signal receiver 138, free space non-directional signal transmitter 126 and conducting cable/optical fiber signal transmitter 128 are not required. Therefore, these optional components are included in FIG. 1B using dashed lines.

As shown in FIG. 1B, a free space directional signal received via free space directional signal receiver 120 may be relayed to signal analysis module 132 to determine whether the incoming signal complies with a set of stored signal characteristic information/requirements 134. Upon determining the status of the incoming free space directional signal, signal analysis module 132 may send a link status update to routing/control module 122 to notify the routing/control module of the status of the directional link and/or any changes in the status of the directional link. Upon receipt of a link status update, routing/control module 122 may update stored network connectivity/routing information 130 to reflect the new status of the directional link. Further, routing/control module 122 may proceed to immediately route/re-route network traffic via an alternate or a more optimal route in response to a link status update indicating that a previously up link has gone down, or a previously down link has been restored, respectively, as described in greater detail below.

User/alert interface 140, if included within network node 118, may allow an operator to manually enter and/or load information into stored signal characteristic information/requirements 134, populate configuration/control parameters within signal analysis module 132, manually enter and/or load information into stored network connectivity/routing information 130, and/or populate configuration/control parameters within routing/control module 122. Using user/alert interface 140, an operator may configure network node 118 to support one or a plurality of free space directional links. Separate signal quality information may be stored for each free space directional link supported by network node 118, or free space directional link signal quality information may be defined for different free space directional link types. For example, stored signal characteristic information/requirements for optics based free space directional links may be different than the stored signal characteristic information/requirements for radio signal based free space directional links and may be separately defined in stored network connectivity/routing information 130 for individual directional links and/or for a set of defined directional link types.

The signal analysis performed by signal analysis module 132 may be performed at either the OSI (Open Systems Interconnection) physical layer and/or at the OSI data link layer. By way of example, if signal analysis module 132 is configured to perform signal analysis at the physical layer, signal analysis module 132 may receive, either directly or from free space directional receiver 120, the physically transmitted signal and signal analysis module 132 may analyze the physical signal based upon stored physical signal characteristic information/requirements. Upon the physical signal falling below or rising above a minimum quality threshold defined by stored signal characteristic information/requirements 134, signal analysis module 132 may send a link status update indicating the status of the link. By way of a second example, if signal analysis module 132 is configured to perform signal analysis at the data link layer, signal analysis module 132 may receive from free space directional receiver 120, logical link control (LLC) error checking information and monitor and assess the error rate based upon stored physical signal characteristic information/requirements. Upon the LLC error rate rising above or falling below a minimum quality threshold for a prescribed time duration defined by stored signal characteristic information/requirements 134, signal analysis module 132 may send a link status update indicating the status of the link. Alternatively, signal analysis module may receive and assess a data link layer data throughput rate, or bit-rate, to determine whether the link is performing satisfactorily.

In accordance with the present invention, routing/control module 114 (FIG. 1A) and routing/control module 122 (FIG. 1B) are immediately notified upon the failure of a free space directional signal and may make immediate routing decisions to minimize disturbances to traffic being routed through the network. By monitoring the free space directional signal in such a manner, the OSI routing layer, executed by routing/control module 114 or routing/control module 122 depending upon the exemplary model used, may avoid the prolonged delay associated with the detection of a failed or restore free space directional link, as described above. Stored network connectivity/routing information, as shown in FIG. 1A and FIG. 1B, may include a plurality of alternate routes, thereby allowing traffic to be immediately routed across an alternate link upon receipt of a link status update indicating that the link is non-operational. Further, stored network connectivity/routing information may include route efficiency/rating values that allow the routing layer to select an efficient alternate route from a plurality of available alternate routes and to route/re-route traffic upon the selected alternate route upon receipt of a link status update indicating that the link is operational.

A link status update, as described above with respect to FIG. 1A and FIG. 1B, may be implemented in any manner that allows a router/routing layer to receive notification of the free space directional link status from either an external free space directional link signal monitor and/or an integrated, internal free space directional link signal analysis module that monitors signals received upon a free space directional link. For example, in one representative embodiment, the link status update may be implemented by the link monitor/signal analysis module by updating information contained in a management information base, or MIB. Information updates to the MIB may be conveyed to a router/routing layer or retrieved by a router/routing layer in any manner. In another representative embodiment, the link status update may be implemented by the link monitor/signal analysis module as an electronic signal, or a change in a level of an electronic signal that is received by the router/routing layer. Such representative link status update embodiments are exemplary only. A link status update may be implemented in any manner that supports the interface requirements of the router/routing layer for which the link status update is intended.

The present invention may be implemented as an enhancement to one or more existing layered communication model protocols or integrated within one or more entirely new communication protocols. For example, OSI compliant EIGRP and OSPF routing protocols include the ability to receive notification of a failure in an electrical or electromagnetic conducting cable or an optical fiber link and to respond (i.e., re-route traffic) immediately. Therefore, a signal analysis module of the present invention, as described above, may be configured to notify an EIGRP or an OSPF routing layer that a free space directional link has been lost by sending a link status update to the EIGRP or OSPF routing layer that emulates or is significantly similar to an EIGRP or OSPF link failure notification associated with failure of a conventional conducting cable or optical fiber based link. Alternatively, another conventional routing protocol may be modified to interface with a signal analysis module, as described above, so that a wide range of link status updates may be received by the routing protocol and used to route/re-route network traffic accordingly, as described above. Otherwise, an entirely new routing protocol may be implemented that includes support for free space directional link monitoring, receipt of status link updates and routing/rerouting network traffic, as described above with respect to FIG. 1A and FIG. 1B.

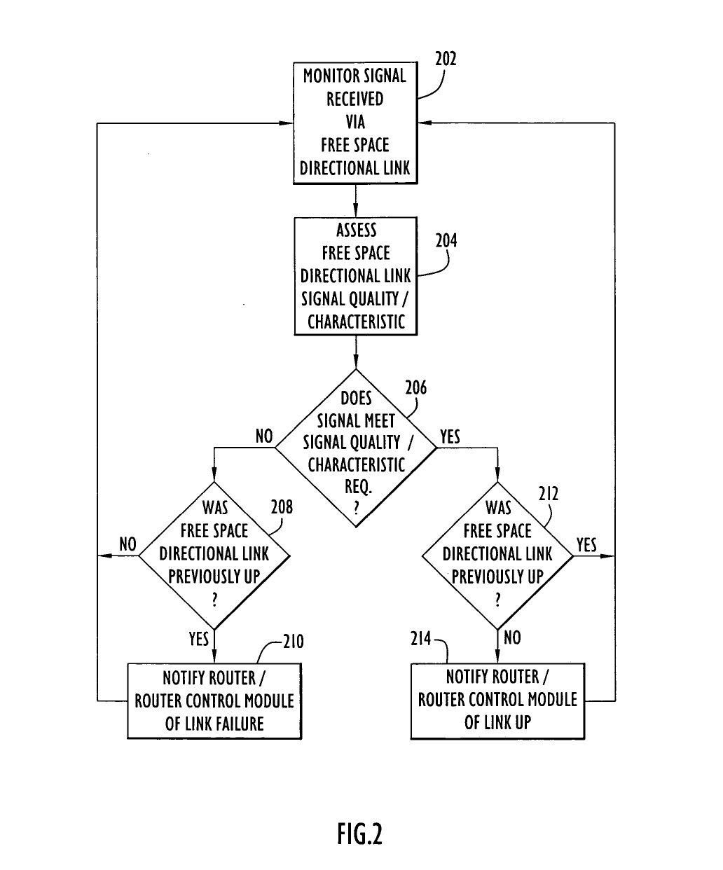

FIG. 2 is a process flow diagram for monitoring a free space directional link and notifying a new or optimized routing device/routing layer protocol of the status of the free space directional link in accordance with an exemplary embodiment of the present invention. As described above with respect to FIG. 1A and FIG. 1B, such a process may be implemented within one or more layered communication protocols at the physical layer, data link layer and/or network layer. As shown in FIG. 2, a free space directional link signal is received/monitored, at step 202, and the quality of the signal is assessed, at step 204, to determine whether the signal quality complies stored signal quality minimum requirements, as described above. If the received signal is determined, at step 206, not to comply with stored signal quality requirements and the free space is determined, at step 208, to have been previously up, the routing layer is notified, at step 210, of a link failure. Upon determining, at step 208, that the free space directional link was not previously up, or upon notifying, at step 210, the router/routing control layer of a link failure, the process flow returns to monitoring, at step 202, the free space directional link signal.

If the received signal is determined, at step 206, to comply with stored signal quality requirements and the free space is determined, at step 212, to have been previously down, the routing layer is notified, at step 214, of the restored digital link. Further, upon determining, at step 212, that the free space directional link was previously up, or upon notifying, at step 214, the router/routing control layer of a link restoration, the process flow returns to monitoring, at step 202, the free space directional link signal.

The techniques used to assess, at step 204, a received free space directional signal to determine whether the signal meets a set of stored signal quality requirements may vary depending upon the nature of the free space directional signal. For example, one approach is to define a threshold signal-to-noise ratio. Upon determining that a signal-to-noise ratio is greater than the allowed threshold, the link is determined to have been lost. Conversely, upon determining that a signal-to-noise ratio is less than the allowed threshold, the link is determined to have been restored. Other approaches may be based upon a received instantaneous signal power or a time-averaged signal power or any other indicia of signal quality.

By monitoring a signal at either the physical signal or data link level, the present invention may avoid reliance upon significantly less frequent control traffic to determine whether a link has been lost or whether a link has been restored. The signal power of any received signal (e.g., an optical or radio frequency signal) may be used because the highly directional nature of the directional link assures that any received signal corresponds to the link in question. For example, in one exemplary embodiment, a measure of the instantaneous and/or time averaged received optical power may be determined at the free space directional link signal monitor and compared against stored signal characteristic information/requirements in order to determine a status of the link and to generate a physical layer interrupt upon determining a status of the link or upon determining that a change in the status of a link has occurred. A customized data link layer protocol may be used to accept an interrupt from the physical layer and change the state of the applicable interface. The routing protocol may then detect this change in state and begin re-routing the traffic.

Assessment of signal quality may include considerations for the possible causes of link failure and characteristics associated with the respective possible causes of link failure. For example, time constants, as well as terminal characteristics such as receiver sensitivity may be considered in determining signal quality threshold values to be used. For instance, with respect to an optical free space directional link, if the most likely cause of a link outage in a network of aircraft is obscuration by large clouds, a decrease in received signal power of −50 to −100 dB may be appropriate as a threshold value for use in determining whether a link has been lost.

Also with respect to optical free space directional links, the characteristic effects of atmospheric turbulence-induced scintillation may be considered when assessing a received optical signal. For example, to avoid unnecessary re-routing of network traffic, an optical free space directional link is preferably not declared a failed link in response to extremely short-term scintillation-induced fades. For example, a loss in signal strength due to typical atmospheric scintillation, with a signal fade on the order of approximately −30 dB and a duration on the order of approximately 1 ms, preferably would not trigger a link failure decision. Therefore, when applied to an optical free space directional link, stored signal characteristic information/requirements may define a duration threshold (greater than the mean scintillation fade duration) that may be assessed in addition to a signal power threshold to determine whether a link has failed. Similar duration thresholds may also be defined for other free space directional links (e.g., directional radio links) based upon the characteristics of the free space directional link and the environment in which the link is used. Further, numerous other techniques, such as N of M sampling techniques may be used to determine the status of a free space directional link. For example, in one N of M sampling approach, a signal characteristic is monitored for M samples and if a common result is obtained for N of the M samples, the link status is updated to reflect the common result associated with the N samples.

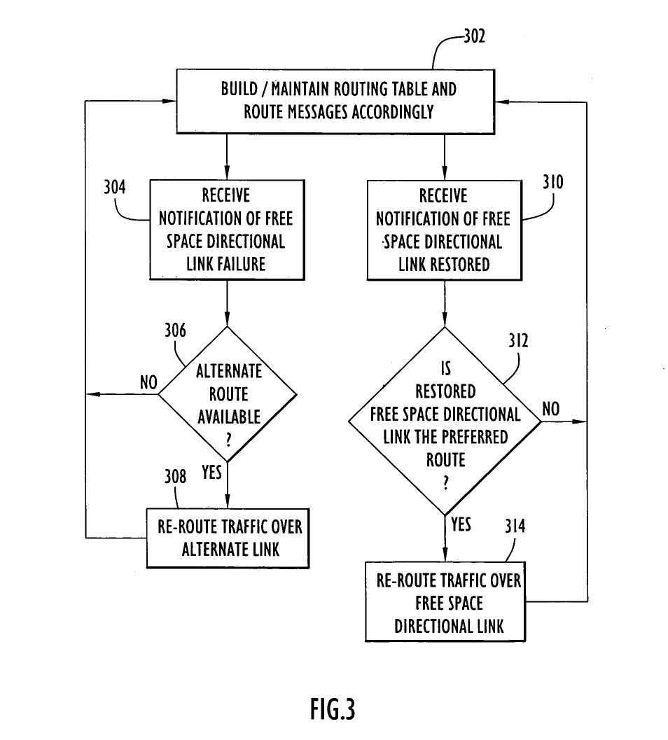

FIG. 3 is a process flow diagram for routing/re-routing messages in a network that includes a free space directional link in response to free space directional link status notifications received from a free space directional link monitor, as described above with respect to FIG. 2. As shown in FIG. 3, a router/routing layer builds and maintains network routing information and routes, at step 302, network traffic based upon the network routing information. Upon receipt, at step 304, of a link status update indicating that a free space directional link is non-operational (i.e., that the link has failed), the routing layer determines, at step 306, whether an alternate route is available. If an alternate route is available, the network traffic is routed, at step 308, over an alternate network link. Upon determining that no alternate route is available, at step 306, or upon re-routing traffic, at step 308, the router/routing layer proceeds with routing table maintenance and message routing, at step 302. Depending upon the routing table maintenance strategy used by the router/routing layer, if no alternate route was available, at step 306, the router/routing layer may initiate discovery requests, at step 302, in an attempt to locate an alternate route by which to deliver the network traffic despite the failed link.

Upon receipt, at step 310, of a link status update indicating that a free space directional link is operational (i.e., that the link has been restored), the routing layer may determine, at step 312, whether the restored link provides access to a preferred route in comparison to the current route. If a preferred route is enabled, the router/routing layer may begin to re-route, at step 314, traffic across the newly restored link. Upon determining that the restored link does not enable a preferred route, at step 312, or upon re-routing traffic, at step 314, the router/routing layer proceeds with routing table maintenance and message routing, at step 302.

Significant performance improvements may be achieved by maximizing the link redundancy at each node to ensure that a node's routing information table includes multiple alternate routes. Such a precaution increases the probability that a re-routing decision may be made locally (e.g., a node may route traffic upon an alternate link supported by the same node as the failed link) and reduces the need for a node's router/routing protocol to search for and discover new routes (e.g., by sending route discovery Hello messages), which may result in additional data traffic transmission delays.

By monitoring a free space directional link, as described above with respect to FIG. 2 and FIG. 3 to detect link failures and link recoveries based upon a set of predetermined link failure and link recovery thresholds, the time required for the router/routing layer to re-route network traffic in response to a failure or recovery of a free space directional link is greatly reduced. For example, re-routing time in a network using EIGRP has been reduced from an average of 12 seconds to less than 10 ms by sending a link status update, as described above, to an existing mechanism in the EIGRP protocol configured to receive notifications of a failed conventional conducting cable or optical fiber based link, as described above.

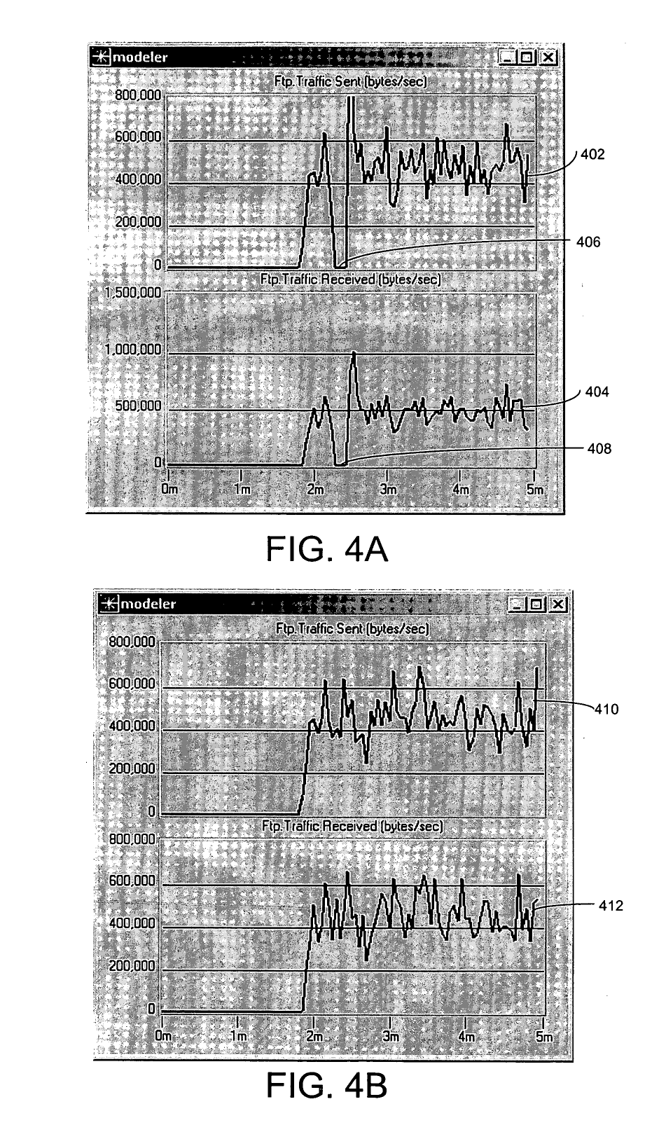

FIG. 4A and FIG. 4B present charts of FTP traffic throughput measured in bytes per second, as seen by a transmitting node (plot 402) and a receiving node (plot 404) in an EIGRP network of free space directional links. FTP data transmission rates for an EIGRP network that has not been optimized to support free space directional link monitoring and status link updates to the router/routing layer is presented in FIG. 4A; while FTP data transmission rates for an EIGRP network that has been optimized to support free space directional link monitoring and status link updates to the router/routing layer is presented in FIG. 4B.

As shown in FIG. 4A, loss of a free space directional link in a network that uses a router/routing protocol that has not been optimized to support free space directional link monitoring may suffer a loss of service due to loss of an active free space directional link, despite the availability of an alternative path. As demonstrated in plot 402 of transmitted data rates, at 406, and in plot 404 of received data rates, at 408, a service outage which exceeds an average of twelve seconds may be introduced by loss of an active free space directional link in a network in which network nodes have not been optimized with free space directional link monitoring and the ability to inform the router/routing layer of changes in free space directional link status.

As shown in FIG. 4B, loss of a free space directional link in a network that uses a router/routing protocol that has been optimized to support free space directional link monitoring does not suffer a loss of service due to loss of a free space directional link. As demonstrated in plot 410 of transmitted data rates and in plot 412 of received data rates, an average delay in data transmission of only 160 ms is introduced by loss of an active free space directional link in a network in which network nodes have been optimized with free space directional link monitoring and the ability to inform the router/routing layer of changes in free space directional link status.

In both FIG. 4A and FIG. 4B, the same level of traffic was transmitted across the network and each node was configured with redundant available links for use in re-routing traffic in the event of an active free space directional link failure. During the test, clouds blocked the line of sight between two nodes supporting an optical free space directional link just after 2 minutes, causing link failures in both scenarios at the same time. As shown in FIG. 4A, in the network that was not optimized to support free space directional link monitoring and status link updates to the router/routing protocol, a 10-second data transmission outage occurred upon failure of the active optical free space directional link, because the routing protocol waited for acknowledgements to multiple failed periodic Hello messages before determining that the free space directional link had failed. Such an approach results in a delay in re-routing network traffic, and subsequent network traffic delays, despite the availability of one or more alternate routes which could have been put to use much sooner to mitigate the impact of the failed free space directional link upon network traffic throughput.

As shown in FIG. 4B, in the network that was optimized to support free space directional link monitoring and to send status link updates to the router/routing protocol, as described above, the data transmission outage corresponding to failure of the active optical free space directional link was reduced to approximately 10 ms. The decrease in transmission delay is due to the fact that the free space directional link monitor was able to immediately notify the router/routing layer of the link failure, allowing the router/routing layer to immediately (i.e., within 10 ms) re-route traffic across an alternate route.

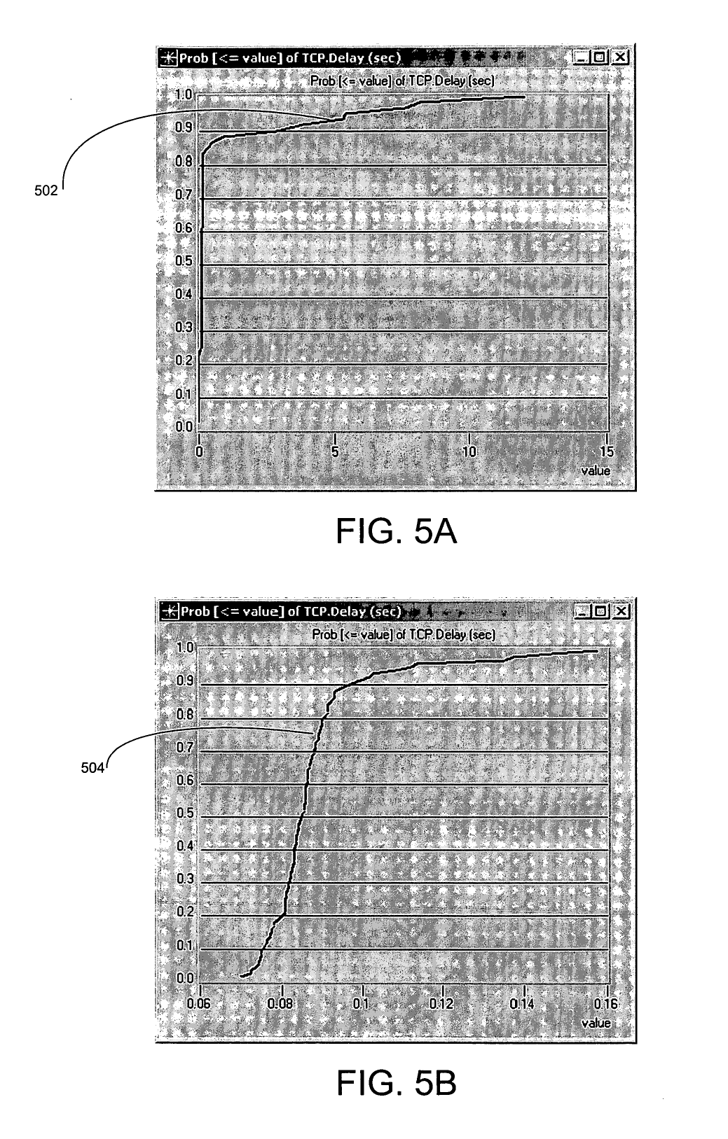

Data transmission delays associated with networks with conventional routers/routing protocols and routers/routing protocols optimized to support free space directional link monitoring are presented in FIG. 5A and FIG. 5B, respectively. As shown in FIG. 5A at plot 502, in a network that includes a free space directional link and nodes with conventional routers/routing protocols, ten percent of the traffic experienced a five to fifteen second delay in transmission in response to failure of an active free space directional link. However, in a network that includes node routers/routing protocols that support receipt of link status updates from free space directional link monitors, the expected network traffic delay in response to failure of an active free space directional link is greatly reduced. As shown in FIG. 5B, the maximum expected network traffic delay in response to failure of an active free space directional link is approximately 0.16 seconds.

It may be appreciated that the embodiments described above and illustrated in the drawings represent only a few of the many ways of applying free space directional link monitoring to reduce transmission delays in networks that include free space directional links. The present invention is not limited to the specific embodiments disclosed herein and variations of the method and apparatus described here may also be used to reduce transmission delays in networks that include free space directional links.

The free space directional link monitor and router/routing layer described here can be implemented in any number of hardware and software units, or modules, and is not limited to any specific hardware module and/or software module architecture. Each module may be implemented in any number of ways and is not limited in implementation to execute process flows precisely as described above. The free space directional link monitor and router/routing layer described above and illustrated in the flow charts and diagrams may be modified in any manner that accomplishes the functions described herein. It is to be understood that various functions of the free space directional link monitor and router/routing layer may be distributed in any manner among any quantity (e.g., one or more) of hardware and/or software modules or units, computer or processing systems or circuitry.

It is to be understood that a router, as described here and as used in the claims, may be any combination of hardware and/or software components that supports routing layer functionality (i.e., the routing of messages between nodes within a network). Such a router may be a stand-alone device, implemented as a software application executed upon a communication node, and/or implemented in any manner that supports message routing functionality. Such a router may or may not be implemented in a manner that reflects a layered communication architecture model (e.g., the OSI layered communication architecture model).

The free space directional link may be a directional link between any two nodes based upon any type of free space signal including electromagnetic signals, optical signals and/or any signal capable of spanning a free space distance. The transmitted free space directional signal may be modulated in any manner and data carried by the signal may multiplexed and/or encoded upon the physical signal in any manner.

The free space directional link monitoring and router/routing capabilities described here may be deployed in a network containing any number and combination of conventional conducting cable/optical fiber based links, free space non-directional links and/or free space directional links. Further, the free space directional link monitoring and router/routing capabilities described here may be deployed in a network containing only free space directional links. Nodes within the network may be stationary and/or mobile and may be deployed upon land, at sea and/or upon airborne and/or space based platforms (e.g., ground personnel, vehicles, ships, planes, satellites, space vehicles, space based platforms, etc.).

It is to be understood that processor based controls for a link monitor, signal analysis module, routing/control module, or any other module included within the free space directional link monitor and router/routing layer may be implemented in any desired computer language and/or combination of computer languages, and could be developed by one of ordinary skill in the computer and/or programming arts based on the functional description contained herein and the flow charts illustrated in the drawings. Further, the free space directional link monitor and router/routing layer may include commercially available components tailored in any manner to implement functions performed by the free space directional link monitor and router/routing layer described here. Free space directional link monitor and router/routing layer component software may be available or distributed via any suitable medium (e.g., stored on devices such as CD-ROM and diskette, downloaded from the Internet or other network via packets and/or carrier signals, downloaded from a bulletin board via carrier signals, or other conventional distribution mechanisms).

The free space directional link monitor and router/routing layer may accommodate any quantity and any type of data files and/or databases or other structures (e.g., ASCII, binary, plain text, or other file/directory service and/or database format, etc.) used to store network connectivity/routing information, stored signal characteristic information/requirements and/or configuration parameters. Further, any references herein to software, or commercially available applications, performing various functions generally refer to processors performing those functions under software control. Such processors may alternatively be implemented by hardware or other processing circuitry. The various functions of the free space directional link monitor and router/routing layer may be distributed in any manner among any quantity (e.g., one or more) of hardware and/or software modules or units. The software and/or processes described above and illustrated in the flow charts and diagrams may be modified in any manner that accomplishes the functions described herein.

From the foregoing description it may be appreciated that the present invention includes a method and apparatus for efficiently detecting a free space directional link failure, for efficiently detecting restoration of a free space directional link, and for efficiently re-routing network traffic in order to minimize network traffic delays and/or to maximize network traffic throughput. By monitoring free space directional links at the physical and/or data link layer, link failures/restorations are identified and the router/routing layer may be quickly notified so that an alternate path may be quickly selected, thereby minimizing network traffic delays due to the failure of a free space directional link and thereby maximizing network throughput by re-routing traffic across an optimal route in response to restoration of a free space directional link.

Having described preferred embodiments of a method and apparatus for optimized routing in networks that include free space directional links, it is believed that other modifications, variations and changes may be suggested to those skilled in the art in view of the teachings set forth herein. It is therefore to be understood that all such variations, modifications and changes are believed to fall within the scope of the present invention as defined by the appended claims.

1. A free space directional link monitor, comprising:
an analysis module to analyze a characteristic of a signal received via a free space directional link to produce an analysis result; and
a status module to generate a link status update that includes at least one of the analysis result and information related to the analysis result;
wherein the link status update is received by a router or a routing layer.

2. The monitor of claim 1, further comprising:
an information module to store one of a signal characteristic information and a signal characteristic requirement;
wherein the analysis performed by the analysis module includes comparing a received signal characteristic to one of said signal characteristic information and signal characteristic requirement.

3. The monitor of claim 2, wherein the information module further includes:
a threshold module to store a signal characteristic threshold value.

4. The monitor of claim 2, wherein the information module further includes:
a range module to store a signal characteristic range.

5. The monitor of claim 1, wherein the status module is configured to generate a link status update that includes an indication of whether the link is one of operational and non-operational.

6. The monitor of claim 1, wherein the status module is configured to generate a link status update that includes an indicator of whether a change in link status has occurred.

7. The monitor of claim 1, wherein the analysis module further comprises:
a physical-layer module to analyze a physical characteristic of the signal received via the free space directional link to produce an analysis result.

8. The monitor of claim 7, wherein the physical signal characteristic is a signal-to-noise ratio.

9. The monitor of claim 7, wherein the physical signal characteristic is a received signal power level.

10. The monitor of claim 9, wherein the received signal power level is one of an instantaneous power level and an average power level.

11. The monitor of claim 1, wherein the analysis module further comprises:
a data-link-layer module to analyze a data link layer characteristic of the signal received via the free space directional link to produce an analysis result.

12. The monitor of claim 11, wherein the data link layer characteristic is one of an error rate and a data transfer rate.

13. A router for routing a message within a network that supports a free space directional link, the router comprising:
a control module to receive and process a status update containing information related to a status of the free space directional link; and
a routing module to route the message based at least in part upon information contained within the status update;
wherein the status update is generated by a free space directional link monitor based upon an analysis of a characteristic of a signal received via the free space directional link.

14. The router of claim 13, wherein the control module is configured to receive a status update indicating one of link failure and link restoration.

15. The router of claim 13, wherein the control module is configured to receive a status update indicating one of a link status and a change in link status.

16. The router of claim 13, further comprising:
an information module to store one of network connectivity and routing information;
wherein the control module updates information stored in the information module in response to receipt of a status update.

17. The router of claim 13, wherein the routing module further comprises:
a re-routing module to re-route a message across one of an alternate route and an optimal route in response to receipt of a change in the status of a free space directional link.

18. A method for monitoring a free space directional link, the method comprising:
(a) analyzing a characteristic of a signal received via the free space directional link to produce an analysis result; and
(b) generating a link status update that includes at least one of the analysis result and information related to the analysis result;
wherein the link status update is received by a router or a routing layer

19. The method of claim 18, further comprising:
(c) storing one of a signal characteristic information and a signal characteristic requirement;
wherein (a) further includes comparing a received signal characteristic to one of said stored signal characteristic information and said stored signal characteristic requirement.

20. The method of claim 19, wherein (c) further includes:
(c.1) storing a signal characteristic threshold value.

21. The method of claim 19, wherein (c) further includes:
(c.1) storing a signal characteristic range.

22. The method of claim 18, wherein (b) further includes:
(b.1) generating a link status update that includes an indication of whether the link is one of operational and non-operational.

23. The method of claim 18, wherein (b) further includes:
(b.1) generating a link status update that includes an indicator of whether a change in link status has occurred.

24. The method of claim 18, wherein (a) further comprises:
(a.1) analyzing a physical characteristic of the signal received via the free space directional link to produce an analysis result.

25. The method of claim 24, wherein (a.1) further includes:
analyzing the physical signal to determine a signal-to-noise ratio.

26. The method of claim 24, wherein (a.1) further includes:
analyzing the physical signal to determine a received signal power level.

27. The method of claim 26, wherein (a.1) further includes:
analyzing the physical signal to determine one of an instantaneous signal power level and an average signal power level.

28. The method of claim 18, wherein (a) further includes:
(a.1) analyzing a data link layer characteristic of the signal received via the free space directional link to produce an analysis result.

29. The method of claim 28, wherein (a.1) further includes:
analyzing one of a data transfer rate and a data error rate.

30. A method for routing a message within a network that supports a free space directional link, the method comprising:
(a) receiving and processing a status update containing information related to a status of a free space directional link; and
(b) routing the message based at least in part upon information contained within the status update;
wherein the status update is based upon an analysis of a characteristic of a signal received via the free space directional link.

31. The method of claim 30, wherein (a) further includes:
receiving a status update indicating one of link failure and link restoration.

32. The method of claim 30, wherein (a) further includes:
receiving a status update indicating one of a link status and a change in link status.

33. The method of claim 30, further comprising:
(c) storing one of network connectivity and routing information;
wherein (a) further includes:
(a.1) storing the information in response to receipt of a status update.

34. The method of claim 30, wherein (b) further comprises:
(b.1) re-routing a message across one of an alternate route and an optimal route in response to receiving a change in the status of a free space directional link.

35. A program product apparatus having a computer readable medium with computer program logic recorded thereon for monitoring a free space directional link, said program product apparatus comprising:
an analysis module to analyze a characteristic of a signal received via a free space directional link to produce an analysis result; and
a status module to generate a link status update that includes at least one of the analysis result and information related to the analysis result;
wherein the link status update is received by a router or a routing layer

36. The program product of claim 35, further comprising:
an information module to store one of a signal characteristic information and a signal characteristic requirement;
wherein the analysis performed by the analysis module includes comparing a received signal characteristic to one of said signal characteristic information and signal characteristic requirement.

37. The program product of claim 35, wherein the status module is configured to generate a link status update that includes an indication of whether the link is one of operational and non-operational.

38. A program product apparatus having a computer readable medium with computer program logic recorded thereon for routing a message within a network that supports a free space directional link, said program product apparatus comprising:
a control module to receive and process a status update containing information related to a status of the free space directional link;
a routing module to route the message based at least in part upon information contained within the status update;
wherein the status update is generated by a free space directional link monitor based upon an analysis of a characteristic of a signal received via the free space directional link.

39. The program product of claim 38, further comprising:
an information module to store one of network connectivity and routing information;
wherein the control module updates information stored in the information module in response to receipt of a status update.

40. The program product of claim 38, wherein the routing module further comprises:
a re-routing module to re-route a message across one of an alternate route and an optimal route in response to receipt of a change in the status of a free space directional link.
